(19) United States
(12) Patent Application Publication
(10) Pub. No.: US 2012/0315059 A1
(43) Pub. Date: Dec. 13, 2012

(54) IMAGE FORMING APPARATUS

(75) Inventor: Toru Katsumi, Toride-shi (JP)

(73) Assignee: CANON KABUSHIKI KAISHA, Tokyo (JP)

(21) Appl. No.: 13/490,888

(22) Filed: Jun. 7, 2012

(30) Foreign Application Priority Data
Jun. 10, 2011 (JP) 2011-130509

(51) Int. Cl. G03G 15/16

(52) U.S. Cl. 399/66

(57) ABSTRACT

An image forming apparatus includes a rotatable intermediary transfer belt; first and second rotatable photosensitive members, arranged along a rotational moving direction of the belt, for carrying toner images; first and second electroconductive transfer rollers; first and second current detectors; an executing portion for executing a detection mode operation in which a first detection voltage is applied to the first roller and a current is detected by the first detector, and a second detection voltage is applied to the second roller and a current is detected by the second detector; and a controller for applying first and second transfer voltages to the first and second rollers in an image forming operation, based on detection results.

### FIELD OF THE INVENTION AND RELATED ART

The present invention relates to an image forming apparatus such as an electrophotographic type copying machine or a printer, more particularly to an apparatus in which a toner images are electrostatically transferred from a plurality of image bearing members.

In a full-color image forming apparatus using the electrophotographic type process, a structure using the intermediary transfer belt is known. With such a structure, there are provided photosensitive members for yellow, magenta, cyan and black colors, on which respective color toner images are formed and are transferred (primary transfer) superimposedly on the intermediary transfer belt, and are transferred all together onto a recording material (secondary transfer). In such an apparatus, a transfer roller comprising a metal roller and an elastic layer of electroconductive foam rubber thereon is widely used as a transfer member, but a resistance value thereof changes with the temperature/humidity in the apparatus. In addition, it is known that the resistance value rises as a result of long term voltage application.

In Japanese Laid-open Patent Application 2006-72247, once the resistance value rises, there is no method to recover the resistance value, apart from exchanging the transfer roller with a new one. Under the circumstances, a transfer roller of a metal roller without the electroconductive foam rubber layer has been proposed, by which the change of the resistance with time can be avoided. The metal roller has another advantage that the transfer roller can be manufactured at low cost.

However, the metal roller does not elastically deform as with the roller having a rubber layer, and therefore, even if the metal roller is press-contacted to the photosensitive member, a primary transfer nip provided thereby is not uniform in the contact pressure.

Therefore, in Japanese Laid-open Patent Application 2006-259639, when the metal roller is used, the metal roller is disposed downstream of the contact nip between the photosensitive member and the intermediary transfer belt, and the intermediary transfer belt is made convex outward. By this, the intermediary transfer belt is wrapped on the photosensitive member to a slight extent, thus forming a transfer nip which provides a uniform pressure by a tension of the intermediary transfer belt.

As for the intermediary transfer belt, thermosetting resin material or thermoplastic resin material in which an electroconductive filler such as carbon black is dispersed to adjust the resistance is molded into a belt. A resistance of such a belt may be different depending on the position in one belt, due to variations of the material and/or a manufacturing condition. Then, a toner image transfer efficiency locally decreases, and the transferred toner image many not be uniform. Furthermore, when the intermediary transfer belt is used in the apparatus for a long term, the resistance value changes with elapse of time with the result of a transfer defect.

Under the circumstances, Japanese Laid-open Patent Application Hei 08-160767 and Japanese Laid-open Patent Application Hei 11-174869 proposes that the resistance value of the intermediary transfer belt is detected for circumferentially divided areas, and a primary transfer voltage and/or a secondary transfer voltage is controlled in accordance with the detected resistance values.

The timing of detecting the resistance of the intermediary transfer belt in other words, a relation between a voltage and a current in the transfer portion is when the image forming apparatus is in operation except for a transfer step operation. For example, the detection is carried out during a waiting time before the stand-by state, after operation check for various parts following actuation of a main switch and before the image formation start. In addition, it is carried out during a period (pre-rotation period) which is after a copying key of the operating portion is depressed or the image forming apparatus receives a printing signal from an external equipment and before the start of the primary transfer step.

On the other hand, in order to detect a resistance of the intermediary transfer belt, it is necessary to detect relations between the voltage and the current (resistance non-uniformity) of the entire circumference by a current or voltage detecting member provided an intermediary transfer belt passing position. For this reason, it is necessary to rotate the intermediary transfer belt at least one full-turn for the detection. In the case of a tandem type full-color apparatus, there are provided a plurality of toner image forming portions, and therefore, it is necessary that a circumferential length of the intermediary transfer belt is long, and also time required for one full rotation is long. Also in the apparatus in which a rotational speed of the intermediary transfer belt is low, the time required for one full rotation is long.

In such a case, the waiting time and/or the pre-rotation is long with the result of delay of the print start, or a long time is required to print.

### SUMMARY OF THE INVENTION

Under the circumstances, the present invention intends to reduce the time required to detect a relation between the voltage and the current in the transfer portion along an entire circumference of the intermediary transfer belt.

According to an aspect of the present invention, there is provided an image forming apparatus comprising a rotatable intermediary transfer belt; a first rotatable photosensitive member and a second rotatable photosensitive member, arranged along a rotational moving direction of said intermediary transfer belt, for carrying toner images; a first electroconductive transfer roller, provided in a side of said intermediary transfer belt opposite from a first contact region where said first photosensitive member and said intermediary transfer belt contact with each other, for transferring the toner image carried on said first photosensitive member onto said intermediary transfer belt in a first transfer portion where said transfer roller contacts said intermediary transfer belt, by application of a first transfer voltage thereto; a second electroconductive transfer roller, provided in a side of said intermediary transfer belt opposite from a second contact region where said second photosensitive member and said intermediary transfer belt contact with each other, for transferring the toner image carried on said second photosensitive member onto said intermediary transfer belt in a second transfer portion where said transfer roller contacts said intermediary transfer belt, by application of a second transfer voltage thereto; a first detecting member for detecting a current flowing to said first electroconductive transfer roller; a second detecting member for detecting a current flowing to said second electroconductive transfer roller; an executing portion for executing, in a period other than a period during which the first and second transfer voltages are applied, a detection mode operation in which a first detection voltage is applied to said first electroconductive transfer roller and a current is detected by said first detecting member, and a second detection voltage is applied to said second electroconductive transfer roller and a current is detected by said second detecting member; and a controller for applying the first transfer voltage and the second transfer voltage to said first electroconductive transfer roller and said second electroconductive transfer roller in an image forming operation on the basis of detection results of said first detecting member and said second detecting member during execution of the detection mode operation.

According to the present invention, when the resistance of the intermediary transfer belt is detected, it is unnecessary to rotate the intermediary transfer belt through one full turn, and therefore, an amount of the rotation of the intermediary transfer belt required for the detection can be reduced.

### BRIEF DESCRIPTION OF DRAWINGS

FIG. 1 is a schematic illustration of an image forming apparatus according to a first embodiment of the present invention.

FIG. 2 is a schematic illustration of a primary transfer portion.

FIG. 3 is a perspective view illustrating an intermediary transfer belt.

FIG. 4 is a block diagram of a control device for the transfer voltage.

FIG. 5 is shows a position (a) of the intermediary transfer belt, with respect to a circumferential direction, at the time of detection start, and a position (b) thereof at the time of first detection end, when a relation between a voltage and a current of a transfer portion is detected.

FIG. 6 shows a detected current mainly at a y position with respect to a position in the circumferential direction of the intermediary transfer belt in a third current detection.

FIG. 7 shows a relation between a voltage and a detected current at the y position in the third current detection.

FIG. 8 is a flow chart for determining a target voltage in the first embodiment.

FIG. 9 is a schematic illustration of a primary transfer portion according to a second embodiment of the present invention.

FIG. 10 shows a detected current mainly at a y position with respect to a circumferential direction position of the intermediary transfer belt in a voltage detection.

FIG. 11 is a flow chart for determining a target voltage in the second embodiment.

FIG. 12 shows a spacing means for the intermediary transfer belt according to a third embodiment of the present invention, in a state (a) that the intermediary transfer belt are contacted with all the photosensitive drums, and in a state (b) that the intermediary transfer belt is spaced from the photosensitive drums other than that for the black color.

### DETAILED DESCRIPTION OF THE PREFERRED EMBODIMENT

Referring to the accompanying drawing, embodiments of the present invention will be described in detail.

### First Embodiment

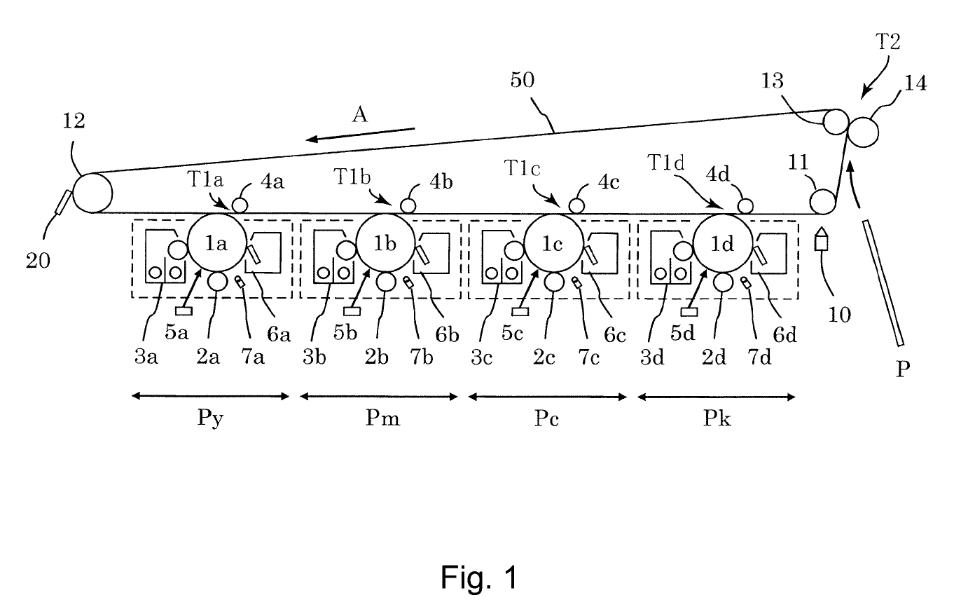

Referring to FIG. 1 to FIG. 8, a first embodiment of the present invention will be described. Referring first to FIG. 1, a structure of an image forming apparatus of this embodiment will be described.

### [Image Forming Apparatus]

FIG. 1 is a sectional general arrangement of a color printer according to the embodiment of the present invention. In the device there are provided a first, a second, a third and a fourth image forming stations Py, Pm, Pc, Pk, different color toner images are formed through a latent image forming step, a developing step and a transfer steps.

A plurality of photosensitive drums (photosensitive members) 1a, 1b, 1c, 1d as image bearing members are rotatably supported, around each of which a developing device 3a, 3b, 3c, 3d and a primary transfer roller 4a, 4b, 4c, 4d as a transfer member is provided. Below an image forming station, an exposure device 5a, 5b, 5c, 5d is provided.

Each of the photosensitive drum 1a-1d is a negative charging type photosensitive drum are rotated by a drum motor (unshown), and is charged to a predetermined potential by charger 2a-2d. Thereafter, a laser beam is emitted from an exposure device 5a-5d in accordance with an image signal and is condensed on the photosensitive drum 1a-1d to scan it along a generatrix of the photosensitive drum 1a-1d to expose the photosensitive drum 1a-1d, by which an electrostatic latent image is formed on the photosensitive drum 1a-1d.

The developing devices 3a-3d contain predetermined amounts of yellow, magenta, cyan and black developers (toner), respectively. The developing devices 3a-3d develop the latent images on the photosensitive drums 1a-1d into yellow, magenta, cyan and black toner images. In this embodiment, a reverse development type is employed, and the toner charged to the negative is deposited onto the exposed portion.

An intermediary transfer belt 50 is provided contacted to the photosensitive drums 1a-1d. The intermediary transfer belt 50 is stretched by a tension roller 11, a driving roller 12 and a back-up roller 13 and is rotated by the driving roller 12 in a direction of an arrow A. Photosensitive drums 1a-1d are arranged along the peripheral moving direction of the intermediary transfer belt 50.

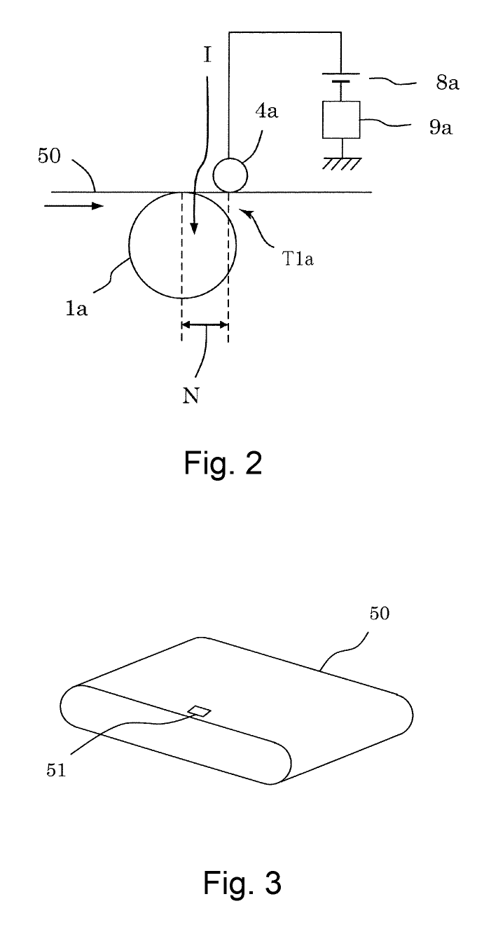

The primary transfer rollers 4a, 4b, 4c, 4d are disposed between the photosensitive drums 1a-1d and the intermediary transfer belt 50. Primary transfer portions T1a, T1b, T1c, T1d are constituted by the photosensitive drums 1a-1d and the primary transfer roller 4a-4d therebetween. The primary transfer rollers 4a-4d are supplied with transfer voltages (positive voltage in this embodiment) of the polarity opposite a charge polarity of the toner by primary high image transfer voltage sources 8a (8b, 8c, 8d, FIG. 2). By this, the toner images formed on the surface of the photosensitive drums 1a-1d are transferred and overlaid on the intermediary transfer belt 50 in the primary transfer portions T1a-T1d, respectively (primary transfer). Thus, a color image comprising four color toner images is formed.

On the surfaces of the photosensitive drums 1a-1d after the toner image transfer, untransferred toner remains, which is removed by cleaning devices 6a, 6b, 6c, 6d and is collected into the toner collection container (unshown). Thereafter, residual charge of the photosensitive drum 1a-1d is removed by discharging by pre-exposure devices 7a, 7b, 7c, 7d, so that the photosensitive drums 1a-1d are prepared for the next time latent image forming operation.

The toner image formed on the intermediary transfer belt 50 as described above, is transferred onto a recording material P fed to a secondary transfer portion T2 by feeding means (unshown). More particularly, the recording material P is fed to a press-contact nip the secondary transfer portion T2) between a secondary transfer roller 14 and a back-up roller 13. The secondary transfer roller 14 is supplied with a secondary transfer voltage (positive voltage this embodiment) of the polarity opposite the charge polarity of the toner, thereby to transfer the four color toner images all together from the intermediary transfer belt 50 onto the recording material P (secondary transfer).

The recording material P having the transferred toner image is fed to a fixing device (unshown), where melting of color mixture of the toner image and fixing of the toner image onto the recording material P are effected, so that a full-color image is formed. The untransferred toner remaining on the intermediary transfer belt 50 moves together with the rotation of the intermediary transfer belt 50, and is removed by a cleaning blade 20 and is collected into a collection container (unshown).

Here, the primary transfer rollers 4a, 4b, 4c, 4d made of metal (metal roller) and has an outer diameter of 8 mm, for example to prevent shaft deformation.

The secondary transfer roller 14 comprises the metal roller and an electroconductive elastic layer on the outer surface thereof, and the elastic layer is made of foam rubber material NBR, urethane, epichlorohydrin or the like in which an ion electroconductive material is added to adjust the resistance value to approx. 1×10̂7-1×10̂9(Ω).

The material of the intermediary transfer belt 50 is resin material such as polyimide, polyamide-imide, polycarbonate, polyethylene terephthalate, polyphenylenesulfide, polyethersulfone, polyetheretherketone or the like. In the resin material, a proper amount of the electroconductive material such as carbon black is added, to provide a volume resistivity of 1×10̂8-1×10̂13 Ωcm, and the resin material is molded into a seamless belt having a thickness of 50-100 μm, thus providing an intermediary transfer belt 50.

### [Primary Transfer Portion]

Referring to FIG. 2, a structure of the primary transfer portion (transfer portion) will be described. FIG. 2 shows a yellow primary transfer portion T1a, but the following description applies to the other color primary transfer portions. The primary transfer roller 4a is disposed at a position deviated downstream with respect to the rotational moving direction of the intermediary transfer belt 50 from a center position of the contact region 0 between the photosensitive drum 1a and the intermediary transfer belt 50. More specifically, it is away from the center position of the contact region by a distance N along the rotational moving direction (advancing direction) of the intermediary transfer belt 50. For example, when the outer diameter of the photosensitive drum 1a are 30 mm, the outer diameter of the primary transfer roller 4a is 8 mm, the distance N is 7 mm, and a distance between the peripheral surface of the photosensitive drum 1a and the peripheral surface of the primary transfer roller 4a is 1 mm.

The primary transfer roller 4a is connected to the primary high voltage for image transfer voltage source 8a and is supplied with a constant voltage provided by a constant voltage control. Designated by reference character 9a is a current detection circuit for detecting a current I flowing to the primary transfer portion T1a. The current I flows from the primary transfer roller 4a into the photosensitive drum 1a through the portion of the intermediary transfer belt 50 in the distance N. The surface potential of the photosensitive drum 1a is at a predetermined level at an upstream side of said contact portion as will be described below. The surface potential of the photosensitive drum 1a changes in accordance with the current I flowing to the photosensitive drum 1a when the surface passes through the contact portion.

By detecting the current I, a relation between the current and the voltage across the primary transfer portion T1a, that is, across the intermediary transfer belt 50 and the photosensitive drum 1a is detected.

When the detection is carried out, the surface potential of the photosensitive drum 1a in the upstream side of said contact portion is set to a predetermined potential. This is because the relation between the voltage across the primary transfer portion T1a and the current is dependent on the surface potential of the photosensitive drum 1a in the upstream side of said contact portion. Specifically, the relation between the voltage across the primary transfer portion T1a and the current shifts by the amount corresponding to the shift of the surface potential of the photosensitive drum 1a in the upstream side of said contact portion.

In this embodiment, the surface potential of the photosensitive drum 1a in the upstream side of said contact portion is made the white background portion potential (dark potential).

### [Position Detection of the Intermediary Transfer Belt in the Circumferential Direction]

Referring to FIG. 3, a structure detected a position of the intermediary transfer belt 50 with respect to the circumferential direction will be described. The intermediary transfer belt 50 is a belt-like member, and one end portion thereof is provided with a mark 51 indicating a reference position with respect to the circumferential direction of the belt. The mark 51 is detected by a mark sensor 10 (FIG. 1) so that the reference position can be detected. The mark sensor 10 comprises a well-known light emission element and a photo-receptor sensor constituting a reflected light quantity detection type, the mark position is discriminated by detecting a difference between the reflected light quantity from the intermediary transfer belt 50 and the mark. The mark sensor 10 is disposed at a position opposed to the tension roller 11.

### [Control of the Transfer Voltage in the Primary Transfer Portion]

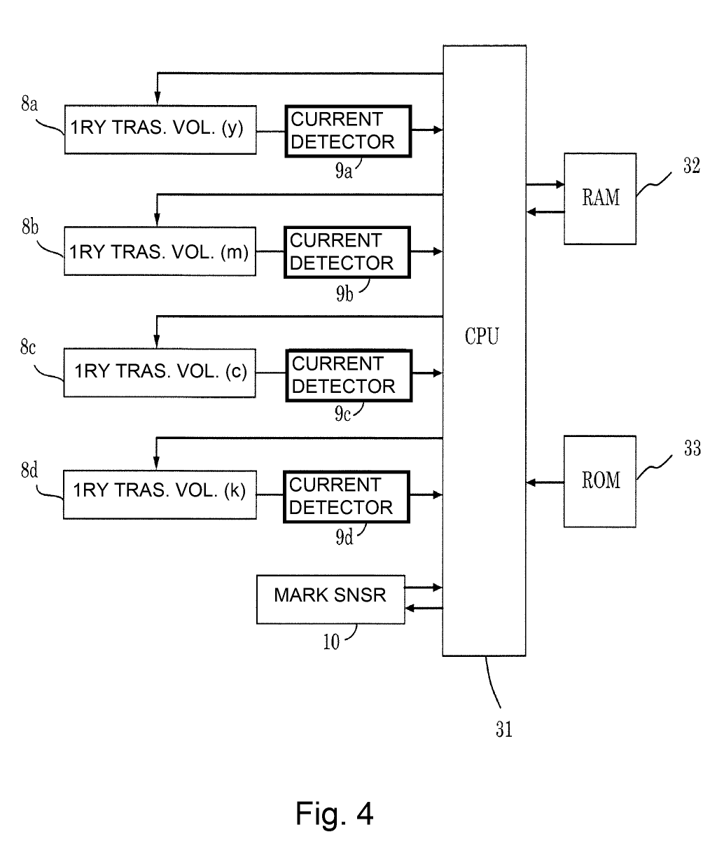

Referring to FIG. 4 to FIG. 8, the control of the transfer voltage of the primary transfer portion will be described. FIG. 4 is a block diagram illustrating a control device for the transfer voltage. Designated by CPU 31 (controller) is a microcomputer for effecting signal processing and calculation process, RAM 32 is memory for storing a detected current, and ROM 33 is a memory storing a program of the control flow which will be described hereinafter.

The CPU 31 is capable of operating the apparatus in a detection mode in which the relation between the voltage and the current in each of the primary transfer portions of the intermediary transfer belt 50 is determined, and in a determination mode in which the transfer voltages to be applied to the primary transfer rollers are determined. The operation in the detection mode, is controlled in accordance with the program stored in the ROM 33, so that the mark sensor 10 detects the reference position of the intermediary transfer belt 50, and thereafter, the primary high voltage for image transfer voltage sources output predetermined voltages at the predetermined timing in accordance with the instructions from the CPU 31. The voltages are applied to the primary transfer rollers 4a-4d, and the currents flowing through the primary transfer portions T1a-T1d are detected by the current detection circuits 9a-9d (detecting member). The signal of the detected current is sent to the CPU 31, and are stored sequentially in the RAM 32. In the determination mode, the CPU 31 calculate and determines the optimum transfer voltages Vt on the basis of the current stored in the RAM 32, and the voltages Vt are applied to the primary transfer rollers in the primary transfer step (at the time of the image transfer) during the image forming operation.

During the image forming operation, the controlled constant voltage is applied. The transfer bias voltage may be applied so as to be a constant voltage or a constant current. Case an intermediate resistance intermediary transfer belt is employed, the constant-current-control may result in a concentrated current flows at a non-toner-image-portion (white background portion) where a potential difference relative to the transfer bias is large, and therefore, the current to a toner image portion is insufficient, which leads to a transfer defect. In order to prevent this, it is preferable to apply a constant voltage during the image transfer in the image forming operation.

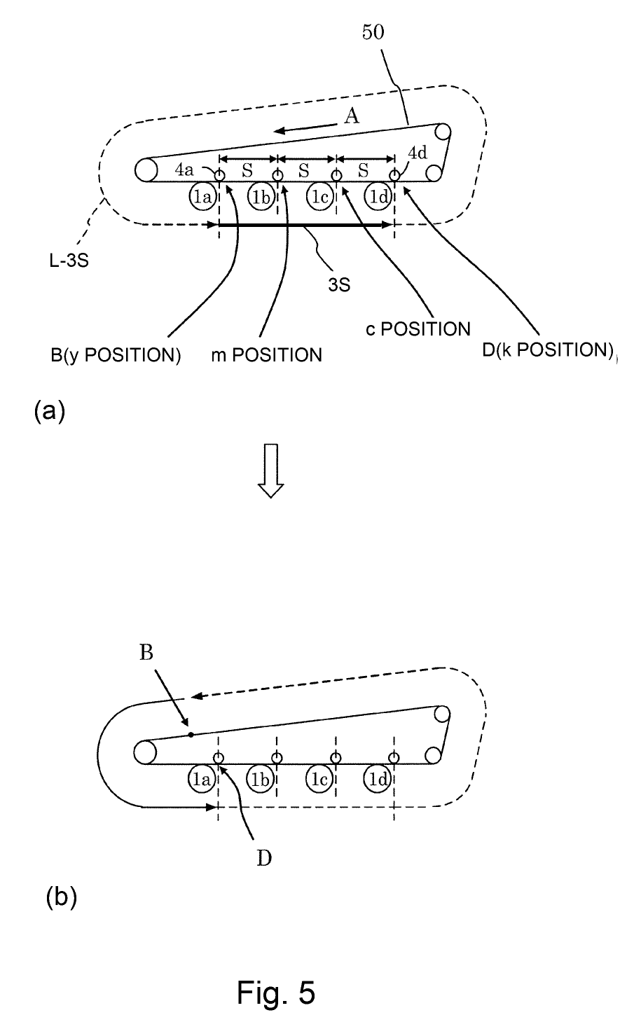

Referring to FIG. 5 to FIG. 8, the control of the transfer voltage in this embodiment will be described in detail. In this embodiment, as described above, the detection mode for detecting the relation between the voltage and the current at each primary transfer portion over the entire circumference of the intermediary transfer belt 50 is executed, and then the determination mode for determining the transfer voltage applied to the primary transfer roller during the transfer is executed. In the detection mode operation of this embodiment, the primary transfer roller is supplied with the constant voltage, and the current is detected by each current detection circuit.

Part (a) of FIG. 5 shows the position of the intermediary transfer belt 50 at the time of start of the detection mode operation, and part (b) of FIG. 5 shows the position of the intermediary transfer belt 50 at the time of the end of the detection mode operation. As shown in (a), the distances between the adjacent primary transfer rollers measured along the intermediary transfer belt 50 is S, and the length of the entire circumference of the intermediary transfer belt 50 is L.

The detection mode operation is started a predetermined time Tt after detection of the reference position of the intermediary transfer belt 50 after start of the rotation of the intermediary transfer belt 50. At the start of the detection mode, y position (primary transfer position for yellow) on the circumference of the intermediary transfer belt 50 is B, and k position (primary transfer position for black) is D. A narrower region (solid line) of the intermediary transfer belt 50 interposed between the positions B and D has a length 3S, and a wider region (broken line) has a length L-3S, along the moving direction.

From the start of the detection mode operation, the predetermined constant voltage is applied to the primary transfer rollers 4a-4d, and while the intermediary transfer belt 50 is rotating, the current is detected by the current detection circuits 9a-9d at regular predetermined intervals ΔT. The intermediary transfer belt 50 rotates, and at the time of the D position arriving at the y position (part (b) of FIG. 5), the resistance detection with this voltage is completed. The current flowing in the broken line portion during the rotation is detected by a current detection circuit 9a at the y position, and the current flowing in the solid line portion is not detected at the y position, but is detected at the k position by a current detection circuit 9d. A part of the broken line portion is detected in the k position. In addition, a part of the broken line portion and a part of the solid line portion are detected also by the current detection circuits 9b and 9c in the m position and the c position.

The description will be made as to the relation between the y position and the k position. The photosensitive drum 1a is a first image bearing member; the photosensitive drum 1d is a second image bearing member; the primary transfer roller 4a is a first transfer member; the primary transfer roller 4a is a second transfer member; the current detection circuit 9a is a first detecting member; and the current detection circuit 9d is a second detecting member. In addition, the primary transfer portion T1a is a first transfer portion; and the primary transfer portion T1d is a second transfer portion.

The controller CPU 31 executes the detection mode operation for determining the relation between the voltage and the current in the primary transfer portion T1a as the first transfer portion of the intermediary transfer belt 50 over the entire circumference of the intermediary transfer belt 50. In detection mode, the intermediary transfer belt 50 is divided into a first region and a second region each of which is shorter than one full circumferential length. In FIG. 5, the broken line portion is the first region. The second region is parts of the solid line portion and the broken line portion in FIG. 5. That is, the second region includes an overlapping region which partly overlaps with the first region, and a rest region (solid line portion) outside a first region. When the first region passes through the first transfer portion (y position), the second region passes through the second transfer portion (k position).

In the first region, the primary transfer roller 4a is supplied with the voltage, and the current detection circuit 9a detects the relation between the voltage and the current of the primary transfer portion T1a. In other words, the relation between the voltage and the current in the y position is detected. In addition, in the second region, the primary transfer roller 4d is supplied with the voltage, and the current detection circuit 9d detects the relation between the voltage and the current of the primary transfer portion T1d. In other words, the relation between the voltage and the current in the k position is detected. By this, the relation between the voltage and the current is detected in the y position of the broken line portion which is the first region. In the overlapping region which is a part of the broken line portion, the relation between the voltage and the current is detected in each of the y position and the k position. However, at this point of time, the relation between the voltage and the current in the y position has not been detected, as long as the solid line portion which is the rest region is concerned.

The relation between the voltage and the current at the y position at least in the rest region is calculated on the basis of the current detected by the current detection circuit 9d in the rest region, taking into account the relation between the current detected in the overlapping region by the current detection circuit 9a and the current detected in the overlapping region by the current detection circuit 9d. In this embodiment, a difference between the current detected in the overlapping region by the current detection circuit 9a and the current detected in the overlapping region by the current detection circuit 9d is added to the current detected by the rest region by the current detection circuit 9d. The calculating method is not limited to the this, and for example, a ratio of the current detected by the overlapping region by current detection circuit 9a to the current detected by the overlapping region by the current detection circuit 9d is multiplied to the current detected by the current detection circuit 9d by the rest region. It will suffice if the relation between the y position and in the k position obtained in the overlapping region is properly reflected in the rest region.

By this, the relation between the voltage and the current at the y position over the entire circumference of the intermediary transfer belt 50 is determined, by the actual detection in the broken line portion which is the first region, by the calculation in the solid line portion which is the rest region, using the result of detection in the k position. As a result, the relation between the voltage and the current in the y position can be determined over the entire circumference of the intermediary transfer belt 50. The same applies to the m position, the c position, and the k position.

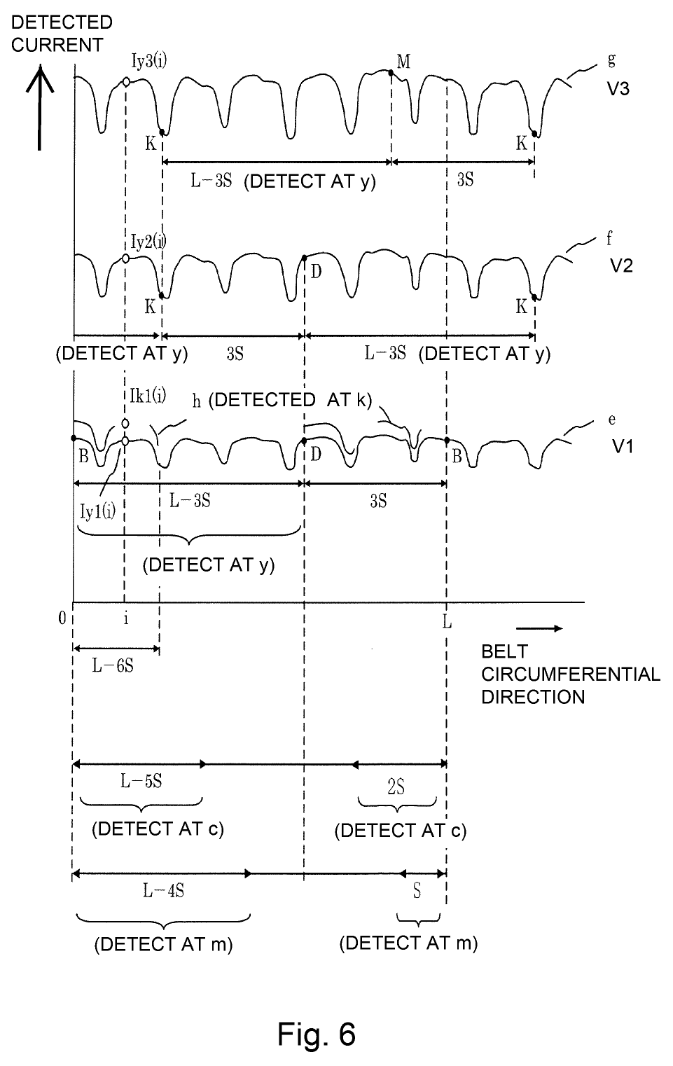

Referring to FIG. 6, more specific description will be made. FIG. 6 is a schematic view showing a distribution of the currents thus detected. The abscissa represents positions on the intermediary transfer belt 50 with respect to the circumferential direction. In the graph, e, f, g are detected currents in the y position when the voltages V1, V2, V3 are applied. The voltages applied to detect the currents are predetermined V1, V2, and V3 which are applied sequentially.

The point of origin of the abscissa in the graph e is a start point of the current detection. A portion of L-3S from B to D in the graph e is the current detected by the current detection circuit 9a in the y position. Therefore, the L-3S portion corresponds to the first region. On the other hand, graph h (broken line) is the current detected by the current detection circuit 9d in the k position. Therefore, the graph h corresponds to the second region. In the graph h, the current is detected in both of the y position and the k position in the range of initial L-6S portion. Therefore, the L-6S portion corresponds to the overlapping region. Here, the detected currents are different. This is because the film thicknesses of the photosensitive members of the photosensitive drums 1a, 1d for yellow and black colors are different from each other. The current flowing into the photosensitive drum is used for charging the photosensitive drum, and is dependent on the film thickness of the photosensitive member which is influential to the electrostatic capacity of the photosensitive drum, and therefore, the relation between the current and the voltage changes depending on a variation of the film thickness of the initial photosensitive member and/or the difference in the wearing amount of the photosensitive member due to the long term operation, as is known.

In the graph e, the current of the rest region where the current detection is not carried out in the y position is calculated as follows. The current difference between the e and h in the first L-6S portion (overlapping region), as described above, is attributable to a resistance difference of the photosensitive drum, and this resistance difference is not dependent on the position of the intermediary transfer belt. Therefore, an averaging current of the currents Iy1 (i) (i is detecting positions on the circumference at the intervals ΔT) of the e in the L-6S is first calculated. That is, an average of the currents detected at the y position in the overlapping region is calculated. Similarly, an averaging current of the current Ikl (i) of h is calculated. That is, an average of the currents detected at the k position in the overlapping region is calculated.

Then, a difference ΔIyk1 between the averaging currents (positive or negative) is calculated. The difference is added to the 3S portion of the h to provide the current detection result in the y position. The difference is added to the detection result in k position in the rest region to provide the current at the y position in the rest region. By doing so, the current at the y position is determined over the entire circumference. There is provided a small gap at a boundary point between the portion of the actual measurement and the calculated portion, but it has been confirmed that the different is so small as to be negligible in terms of the control accuracy.

On the other hand, in order to calculate for the unmeasured portion (portion between the broken lines in the graph h) in the graph h, the difference Δlky1 (−ΔIyk1) is added to the-e. In other words, above-described the relation between the first and the second in the y position and the k position is interchanged. Then, the result is that the graph h corresponds to the first region; the L-3S portion of the graph e corresponds to the second region; the 3S portion corresponds to the overlapping region; and the unmeasured portion of the graph h corresponds to the rest region. Therefore, the difference determination for the overlapping region is added to the result of the y position detected in the rest region, by which the calculation is made for the k position in the unmeasured portion. By doing so, the current at the k position is determined over the entire circumference.

The current at the c position is calculated in the similar manner. For the first L-5S portion, the currents are detected at both of the y position and the c position. That is, the portion is the overlapping region. Therefore, an averaging current of the detected currents at the c position for the L-5S region is calculated, and a difference ΔIky1 between the average and the averaging current of the e is calculated. And, the difference is added to the current of the e in the portion (L-5S-2S in FIG. 6) where the current is not detected at the c position to provide the current at the c position.

The similar calculation is carried out also as to the current at the m position. For the first L-5S portion, the currents are detected at both of the y position and the m position. That is, the portion is the overlapping region. Therefore, an averaging current of the detected currents at the m position for the L-4S region is calculated, and a difference ΔIym1 between the average and the averaging current of the e is calculated. And, the difference is added to the current of the e in the portion (L-4S—S in FIG. 6) where the current is not detected at the m position to provide the current at the m position.

The positions (colors) to be compared are not limited to the combination described above. For example, the m position or the c position may be used in combination with the k position. Once the current all over the entire circumference at any one position (for any one color) is determined, the currents at the other positions (colors) may be calculated on the basis of the determined current, using the positional relations. Thus, the above-described calculation result may be used at least in the rest region, and the above-described calculation result may be used for the actually detected region or regions. For example, the current is determined over the entire circumference in the y position, and the current relations between the y position and the m, c and k positions (colors), and then the currents at the respective positions (for respective colors) can be calculated by add in g the respective relations to the current of the y position. For the positions for m, c and k colors, all of the currents for the range 0-L may be determined by calculation.

In any of the ways described above, the detected currents for each of the positions (each color) with the voltage V1 can be determined. Referring to f of FIG. 6, the current detection when the voltage V2 is applied will be described. Following the completion the current detection with the voltage V1 (part (b) of FIG. 5), the voltage is switched to V2, and the current detection is carries out. In the f, the portion to be detected in the y position is the range L-3S, that is, from D to K. The rest 3S portion is detected in the k position. In FIG. 6, the current distribution Ik2 (i) detected in the k position is omitted. In the range of the length L-6S from the D position, the detection is carried out by both of the y position and the k position, and therefore, similarly to the above-described manner, a difference ΔIyk2 between the averaging currents for the portion L-6S is calculated. The difference Ik2 (i) is added to the 3S portion to provide the current Iy2 (i) in the y position. Similarly, the calculations are carried out also for the currents at the c position and the m position. Further similarly, the current distribution when the voltage V3 is applied is calculated as shown in g of FIG. 6.

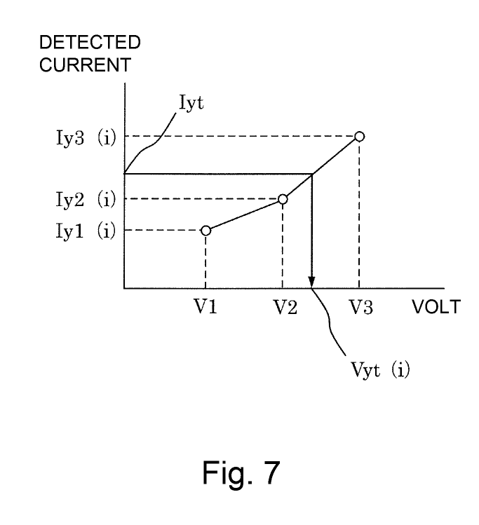

In this manner, with the voltage Vj (j=1, 2, 3), the currents Iyj (i), Imj (i), Icj (i) and, Ikj (i) at each color position (for each color). On the basis of the results, the optimum transfer voltage for a target current is determined (determination mode). Referring to FIG. 7, there is shown a calculating method for the optimum voltage. FIG. 7 is a graph of plots of the relation between the voltage and the current in the y position, and a line interpolation is effected. The target current Iyt is determined by experiment and stored in the ROM 33. As will be understood from FIG. 7, the optimum voltage for flowing the target current Iyt is Vyt (i). The optimum voltage is determined for each circumferential position i to determine the primary transfer voltage for yellow over the entire circumference. Similarly, the primary transfer voltage is determined for the other colors.

During the image forming operation, that is, when the toner image is transferred, the voltage application is started a predetermined time Tt after detection of the reference position mark, the voltage is switched for each position (at the interval of ΔT) to said optimum voltage. By doing so, a constant target current can be applied at all times irrespective of the resistance non-uniformity of the intermediary transfer belt 50, and therefore, a constant transfer efficiency can be provided irrespective of the position of the intermediary transfer belt 50, and satisfactory images can be provided without the density reduction.

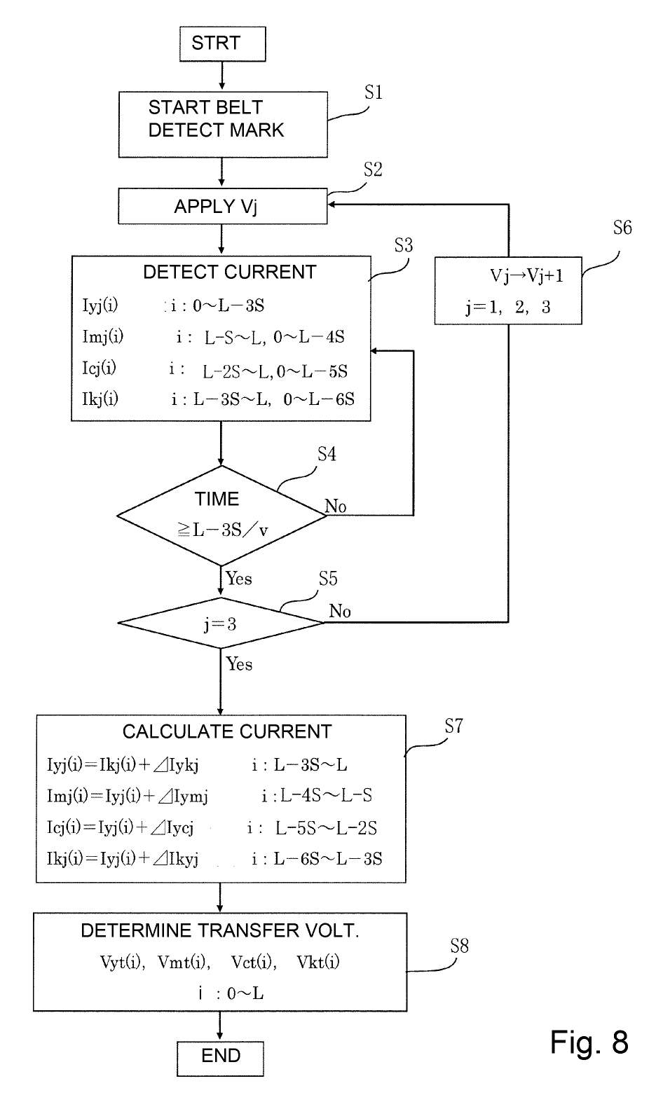

FIG. 8 shows a flow chart of the above-described control operation. First, the reference mark is detected (S1) when the rotation of the intermediary transfer belt 50 starts. Subsequently, the primary transfer voltage Vj (j=1, 2, 3) is applied (S2), and the currents in the predetermined regions are detected in respective positions (respective primary transfer portions) (S3). This is carried out until the rotation time reaches (L-3S)/v, where v is a rotational speed of the intermediary transfer belt 50 (S4). In other words, this is carried out during the intermediary transfer belt 50 moving through L-3S. Such detections are carried out a plurality of times (three times in this embodiment) with different voltages (S5, S6). Then, as described hereinbefore, for the portions not detected at the positions, the currents are calculated on the basis of the relation with the detected results. Then, the graph as shown in FIG. 7 is determined, and the transfer voltages at the respective positions are determined (S8).

For example, the following values for respective parts are taken.

Rotational speed of the intermediary transfer belt 50 during the detection mode: v=120 mm/sec (the same as with the image forming operation):

A total circumferential length of the intermediary transfer belt 50: L=800 mm:

A distance between the primary transfer roller: S=65 mm:

A length of the solid line portion of the intermediary transfer belt 50: 3S=195 mm:

A length of the broken line portion of the intermediary transfer belt 50: L-3S=605 mm:

Then, the time required for one full rotation of the intermediary transfer belt 50 is 800 mm/120 mm/sec=6.67 sec. On the other hand, the required for the detection mode operation for the first applied voltage is 605 mm (L-3S)/120 mm/sec=5.04 sec. Therefore, the time required for the detection mode can be reduced by 1.6 sec for one applied voltage, as compared with the case in which one full rotation of the intermediary transfer belt 50 is required. In the case that three different voltages are used, the time required for the full operation of the detection mode can be reduced by 1.6 secx3=4.8 sec.

The above-described detection time interval ΔT of the current is set so as to be shorter than the time in which a length N=7 mm off the nip between the photosensitive drum and the primary transfer roller passes the position of the primary transfer roller (7 mm/120 mm/sec=58.3 msec). For example, it is ΔT=50 msec. This is because the current flowing into the photosensitive drum from the primary transfer roller is dependent upon the entire resistance of the region of the length N, and therefore, by detecting the current at the interval shorter than the distance N, the current variation attributable to the resistance non-uniformity can be detected with high accuracy.

In this embodiment, the detected current is corrected taking into account the resistance differences among the photosensitive members for the respective colors, but if the variation in the initial film thicknesses of the photosensitive members and the wearing amount difference are sufficiently small, the correction flow operation may be omitted.

According to this embodiment, the current detection by the current detection circuit for the rest regions in the transfer portions is not necessary, and therefore, the rotation amount of the intermediary transfer belt 50 in the detection mode can be reduced. Then, the detection time for determining the relation between the voltage and the current of the intermediary transfer belt 50 over the entire circumference can be shortened. As described hereinbefore, according to this embodiment, the relation between the voltage and the current in each transfer portion can be determined over the entire circumference without the necessity for one full turn of the intermediary transfer belt 50 for each applied voltage. Therefore, the detection relating to the resistance of the entire circumference of the intermediary transfer belt 50 can be reduced.

Particularly, in this embodiment, a metal roller is used for the primary transfer roller. In a device using such a metal roller, a resistance of the primary transfer roller is small, and a distance from the primary transfer roller to the photosensitive member along the intermediary transfer belt is large. Therefore, the resistance of the intermediary transfer belt is dominant in the factors determining the level of the current flowing into the primary transfer portion. Therefore, the current the due to the resistance non-uniformity of the intermediary transfer belt becomes remarkable, and the voltage control corresponding to the resistance of the intermediary transfer belt is desired. In this embodiment, the time required for the execution of the detection mode can be shortened as described above, and therefore, this embodiment is particularly preferable with the structure using such a metal roller.

### Second Embodiment

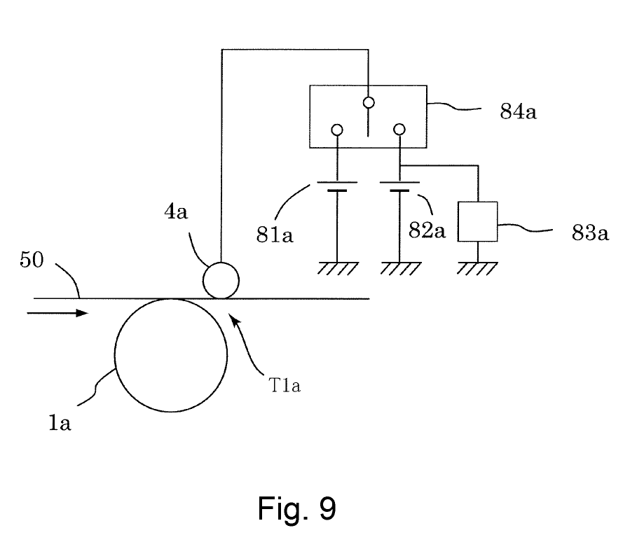

Referring to FIG. 9 to FIG. 11, a second embodiment of the present invention will be described. In the first embodiment, three voltages V1, V2, V3 are applied, and therefore, the intermediary transfer belt has to be rotated a plurality of times. This is because the voltage range is required to be so wide that the optimum voltage to be calculated is within the range of V1-V3. In this embodiment, the detection mode is carried taken out with a constant current, and therefore, the number of rotations can be reduced and the required detection time can be reduced, as compared with the first embodiment.

FIG. 9 shows a voltage source structure for a yellow primary transfer portion T1a. Designated by 81a is a constant voltage source for applying, to the primary transfer roller 4a, a constant voltage provided by a constant-voltage-control during the image forming operation; and 82a is a constant current source for flowing, through the primary transfer roller 4a, the constant current provided by a constant current control. Designated by 83a is a voltage detection circuit for detecting an output voltage of the constant current source 82a; and 84a is a switch for switching the voltage source conducted to the primary transfer roller 4a. The structures are the same with respect to the other colors, and 81b, 81c, 81d are constant voltage sources for the magenta, cyan and black colors. The same applies to the constant current sources 82b, 82c, 82d and the voltage detection circuits 83b, 83c, 83d.

Referring to parts (a) and (b) of FIG. 5, start and completion of the detection mode operation will be described. Upon start of the detection mode operation, predetermined target currents Iyt, Imt, Ict, Ikt are applied to the primary transfer roller for each color from the constant current sources. Subsequently, while rotating the intermediary transfer belt 50, voltages Vyt, Vmt, Vct, Vkt are detected by the voltage detection circuits 83a-83d at predetermined time intervals ΔT.

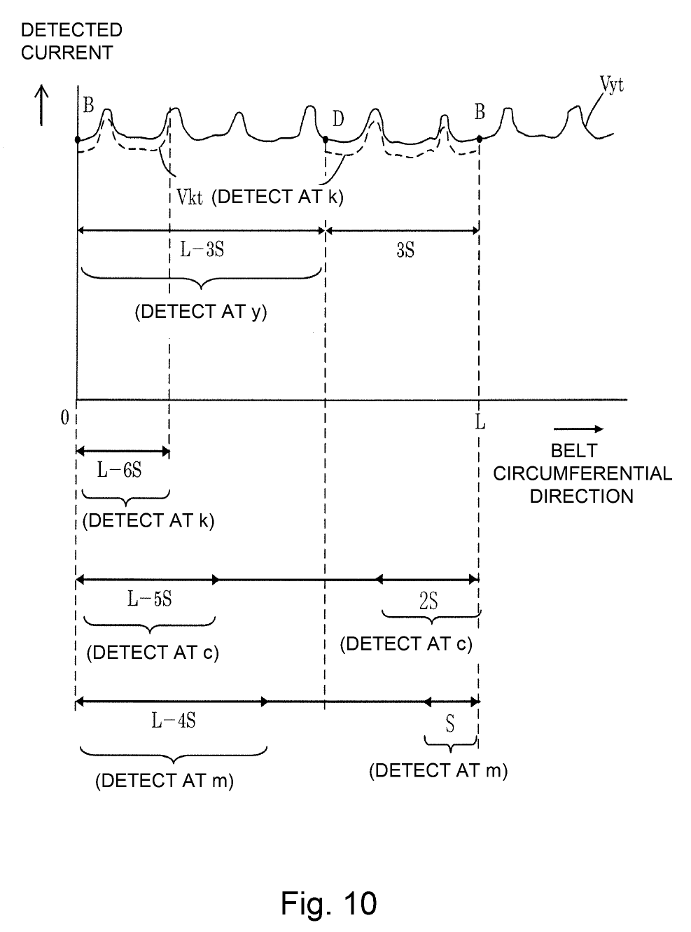

Similarly to the above-described first embodiment, a relation between the y position and the k position will be described. FIG. 10 shows detected voltages. In the Vyt, the initial portion L-3S (first region) are the voltages detected in the y position. A broken line Vkt (second region) are the voltages detected in the k position. As to the rest 3S portion (rest region) in the Vyt, the calculation is made on the basis of the detected voltage Vkt in the k position. For the initial L-6S portion (overlapping region), the voltage is detected by both in the y position and in the k position, and there is a difference between the detected voltages in these positions.

The difference exists because the voltage required to flow the current is different when the target currents Iyt and Ikt are different from each other, in addition to the resistance difference among the photosensitive drums. As for the calculating method the averaging voltage of the Vyt and Vkt in the L-6S portion is calculated, and the difference ΔVykt between the them is added to the Vkt of the 3S portion to provide Vyt. By this, Vyt (i) (i is positions at the ΔT on the circumference) all over the circumference.

On the other hand, the unmeasured portion of the Vkt (between the broken lines), the calculation can be made by exchanging the relation between the first and the second for the y position and the k position, similarly to the first embodiment. That is, the portion corresponds to the rest region in the k position, and the difference ΔVkyt (−ΔVykt) determined in the overlapping region is added to the detected Vyt in the y position of this region. By this, the Vkt (i) can be determined all over the circumference. The same process is applied to the detected voltage Vmt (i) and Vct (i) in the m position and the c position.

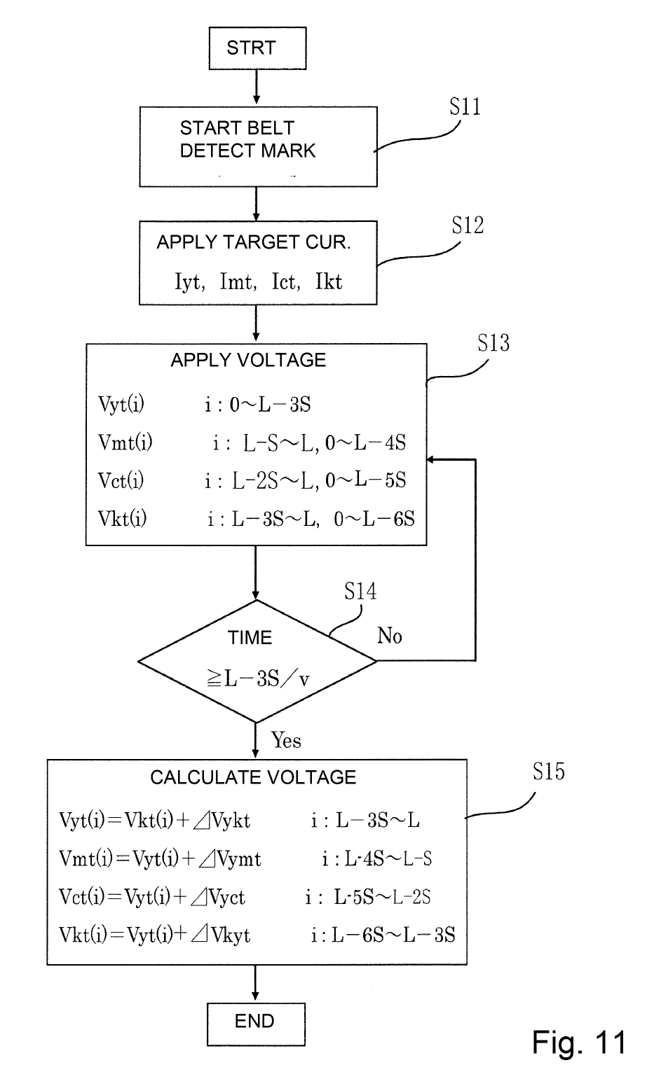

FIG. 11 shows a flow chart of the above-described control operation. First, the reference mark is detected (S11) when the rotation of the intermediary transfer belt 50 starts. Subsequently the constant current (target current) is applied to the primary transfer portion (S12). Then, voltages in the predetermined region are detected in the respective color positions (primary transfer portions) (S13). This is carried out until the rotation time reaches (L-3S)/v, where v is a rotational speed of the intermediary transfer belt 50 (S14). In other words, this is carried out during the intermediary transfer belt 50 moving through L-3S. Then, as described hereinbefore, for the portions not detected at the positions, the currents are calculated on the basis of the relation with the detected results (S15). The transfer voltage at each color position is determined from the detected result and the calculated result.

The voltage Vyt (i), Vmt (i), Vct (i) and, Vkt (i) are applied during the image forming operation while switching for each position i by the constant voltage sources 81a-81d. By doing so, in each primary transfer portion, the target current Iyt, Imt, Ict, Ikt flows, thus maintaining the satisfactory toner image transfer efficiency.

In the case of this embodiment, the voltage is detected while flowing the constant target current, and therefore, only one current is required for the detection, it will suffice if the intermediary transfer belt is rotated through a distance L-3S. For this reason, the detection time can be saved further.

The positions (for colors) to be compared are not limited to the combination described above. For example, the m position or the c position may be used in combination with the k position. Once the voltage at one of positions (for one of the colors) all over the circumference is determined, the voltages at other positions may be calculated on the basis of the determination voltage and the positional relations. For example, the voltage is determined over the entire circumference in the y position, and the voltage relations between the y position and the m, c and k positions (colors), and then the voltages at the respective positions (for respective colors) can be calculated by add in g the respective relations to the voltage of the y position. For the positions for m, c and k colors, all of the voltages for the range O— L may be determined by calculation. The other structures and effects are similar to those of the above-described first embodiment.

### Third Embodiment

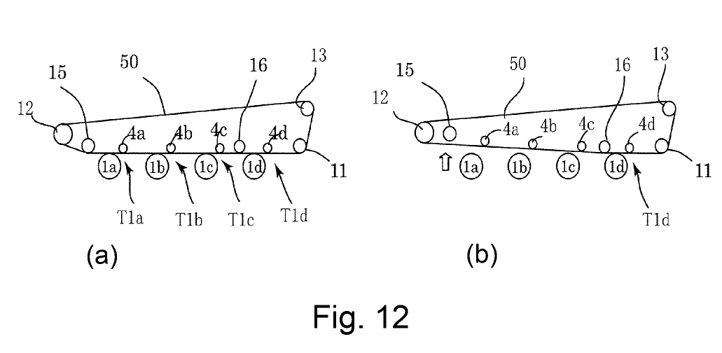

Referring to FIG. 12, a third embodiment of the present invention will be described. A tandem type color image forming apparatus is provided with an image forming station for each color. In this embodiment, in the monochromatic image formation for carrying out a black monochromatic image formation in a monochromatic image forming mode, only the image forming station for the black color is operated, and the other color image forming stations are kept at rest. In such a case, the intermediary transfer belt 50 rotates while the yellow, magenta and cyan photosensitive drums 1a-1c are at rest. In view of such circumstances, a spacing means is provided to space the intermediary transfer belt 50 from the yellow, magenta and cyan photosensitive drums, so that in the monochromatic mode operation, the intermediary transfer belt is spaced therefrom, thus preventing unnecessary deterioration of the photosensitive drums.

In this embodiment, there are provided a supporting roller 16 supporting the intermediary transfer belt 50 from an inside thereof, and a spacing roller 15 (spacing means). The spacing roller 15 moves the intermediary transfer belt 50 about the supporting roller 16 by a cam mechanism (unshown).

By this, the intermediary transfer belt 50 is moved in the direction toward and away from the photosensitive drums 1a-1c. At this time, primary transfer rollers 4a, 4b, 4c move together therewith.

Part (a) of FIG. 12 shows an operation state during full-color image formation in which the intermediary transfer belt 50 is in contact with all the photosensitive drums 1a-1d. On the other hand, part (b) of FIG. 12 shows an operation state in the monochromatic image forming operation, in which the spacing roller 15 is retracted in a direction indicated by the arrow, and the intermediary transfer belt 50 is kept non-contact relative to the photosensitive drums 1a-1c by a tension provided by the tension roller 11. In this embodiment, the photosensitive drums 1a-1c correspond to the second image bearing members, and the photosensitive drum 1d corresponds to the first image bearing member.

In the case that the detection mode operation is executed with the device having such a spacing means, the current or the voltage can be detected only at the primary transfer portion for the black color in the state of (b), and therefore, it is necessary to rotate the intermediary transfer belt 50 one full-turn at least, with the result of long detection time. In the detection mode, the intermediary transfer belt is contacted to all the photosensitive drums, as shown in part (a). The relation between the voltage and the current in the primary transfer portion T1d for the black color is determined, all over the circumference. At this time, above-described with the first embodiment or the second embodiment, the voltage or the current can be detected using the primary transfer portions for the yellow (or magenta or cyan color and the black color, and therefore, the detection time can be reduced.

### Other Embodiments

In each of the embodiments, the first image bearing member is any one of the photosensitive drums, and the second image bearing member is one of the other photosensitive drums. However, the present invention is not limited to such structures, and the second image bearing member may be one or more other photosensitive drums. For example, the yellow photosensitive drum 1a is taken as the first image bearing member, and the magenta, cyan and black photosensitive drums 1b-1d are taken as the second image bearing members.

Then, as to the undetected rest region by the primary transfer portion T1a for the yellow color (first transfer portion), the calculation is carried out using the detection result in the overlapping region with the other color. As for the calculating method, for example, the difference from each color data is calculated, an average of them is added to another color result of the detection, or an optimum color difference and detection result may be selected in accordance with the condition determined beforehand by the experiment. By determination, at least for the rest region, by calculation using the relation relative to the other color detection result, the rotation amount of the intermediary transfer belt 50 in the detection mode can be reduced, and the detection time can be reduced.

While the invention has been described with reference to the structures disclosed herein, it is not confined to the details set forth, and this application is intended to cover such modification or changes as may come within the purposes of the improvements or the scope of the following claims.

This application claims priority from Japanese Patent Application No. 2011-130509 filed Jun. 10, 2011 which is hereby incorporated by reference.

1. An image forming apparatus comprising:
a rotatable intermediary transfer belt;
a first rotatable photosensitive member and a second rotatable photosensitive member, arranged along a rotational moving direction of said intermediary transfer belt, for carrying toner images;
a first electroconductive transfer roller, provided at a side of said intermediary transfer belt opposite from a first contact region where said first photosensitive member and said intermediary transfer belt contact with each other, for transferring a toner image carried on said first photosensitive member onto said intermediary transfer belt in a first transfer portion where said first electroconductive transfer roller contacts said intermediary transfer belt, by application of a first transfer voltage thereto;
a second electroconductive transfer roller, provided at a side of said intermediary transfer belt opposite from a second contact region where said second photosensitive member and said intermediary transfer belt contact with each other, for transferring a toner image carried on said second photosensitive member onto said intermediary transfer belt in a second transfer portion where said second electroconductive transfer roller contacts said intermediary transfer belt, by application of a second transfer voltage thereto;
a first detecting member for detecting a current flowing to said first electroconductive transfer roller;
a second detecting member for detecting a current flowing to said second electroconductive transfer roller;
an executing portion for executing, in a period other than a period during which the first transfer voltage and the second transfer voltage are applied, a detection mode operation in which a first detection voltage is applied to said first electroconductive transfer roller and a current is detected by said first detecting member, and a second detection voltage is applied to said second electroconductive transfer roller and a current is detected by said second detecting member; and
a controller for applying the first transfer voltage and the second transfer voltage to said first electroconductive transfer roller and said second electroconductive transfer roller, respectively, in an image forming operation on the basis of detection results of said first detecting member and said second detecting member during execution of the detection mode operation.

2. An apparatus according to claim 1, wherein said first electroconductive transfer roller and said second electroconductive transfer roller are metal transfer rollers, and
wherein center positions of said first transfer portion and said second transfer portion with respect to the rotational moving direction of said intermediary transfer belt are deviated from center positions of said first contact region and said second contact region with respect to the rotational moving direction of said intermediary transfer belt, respectively, toward a downstream direction with respect to the rotational moving direction of said intermediary transfer belt.

3. An apparatus according to claim 1, wherein the detection mode operation is executed in a period from application of the first detection voltage and the second detection voltage to the first electroconductive transfer roller and the second electroconductive transfer roller, respectively, to passage of all portions of said intermediary transfer belt, with respect to the rotational moving direction, through at least one of said first transfer portion and said second transfer portion.

4. An apparatus according to claim 1, wherein where L is a circumferential length of said intermediary transfer belt, and S is a distance between said first transfer portion and said second transfer portion in the rotational moving direction,
wherein the detection mode operation is carried out from application of the first detection voltage and the second detection voltage to said first electroconductive transfer roller and said second electroconductive transfer roller, respectively, to rotation of said intermediary transfer belt through a distance equal to L−S.

5. An apparatus according to claim 1, wherein said controller applies, during an image forming operation, the first transfer voltage and the second transfer voltage to said first electroconductive transfer roller and said second electroconductive transfer roller, respectively, on the basis of a surface potential of said first photosensitive member at a position upstream of said first contact region with respect to the rotational moving direction of said photosensitive member and a detection result of said first detecting member, and on the basis of a surface potential of said second photosensitive member at a position upstream of said second contact region with respect to the rotational moving direction of said photosensitive member and a detection result of said second detecting member.

6. An apparatus according to claim 1, further comprising switching means for switching between an operation state in which said second photosensitive member and said intermediary transfer belt contact with each other and an operation state in which said second photosensitive member and said intermediary transfer belt are spaced from each other, while said first photosensitive member and said intermediary transfer belt are in a contact state with each other,
wherein said executing portion executes the detection mode operation while said switching means maintains the contact state of said first photosensitive member with said intermediary member.

7. An apparatus according to claim 1, wherein a plurality of photosensitive members is provided along the rotational moving direction of said intermediary transfer belt, and
wherein said first photosensitive member is one of said plurality of photosensitive members, and said second photosensitive member is an other of said plurality of photosensitive members.

8. An apparatus according to claim 7, wherein said first photosensitive member is one of a most upstream and a most downstream of said plurality of photosensitive members with respect to the rotational moving direction of said intermediary transfer belt, and said second photosensitive member is the other of the most upstream and the most downstream of said plurality of photosensitive members.

9. An image forming apparatus comprising:
a rotatable intermediary transfer belt;
a first rotatable photosensitive member and a second rotatable photosensitive member, arranged along a rotational moving direction of said intermediary transfer belt, for carrying toner images;
a first electroconductive transfer roller, provided at a side of said intermediary transfer belt opposite from a first contact region where said first photosensitive member and said intermediary transfer belt contact with each other, for transferring a toner image carried on said first photosensitive member onto said intermediary transfer belt in a first transfer portion where said first electroconductive transfer roller contacts said intermediary transfer belt, by application of a first transfer voltage thereto;
a second electroconductive transfer roller, provided at a side of said intermediary transfer belt opposite from a second contact region where said second photosensitive member and said intermediary transfer belt contact with each other, for transferring a toner image carried on said second photosensitive member onto said intermediary transfer belt in a second transfer portion where said second electroconductive transfer roller contacts said intermediary transfer belt, by application of a second transfer voltage thereto;
a first detecting member for detecting a voltage applied to said first electroconductive transfer roller;
a second detecting member for detecting a voltage applied to said second electroconductive transfer roller;
an executing portion for executing, in a period other than a period during which the first transfer voltage and the second transfer voltage are applied, a detection mode operation in which a first detection current is applied to said first electroconductive transfer roller and a voltage is detected by said first detecting member, and a second detection current is applied to said second electroconductive transfer roller and a voltage is detected by said second detecting member; and
a controller for applying the first transfer voltage and the second transfer voltage to said first electroconductive transfer roller and said second electroconductive transfer roller, respectively, in an image forming operation on the basis of detection results of said first detecting member and said second detecting member during execution of the detection mode operation.

10. An apparatus according to claim 9, wherein said first electroconductive transfer roller and said second electroconductive transfer roller are metal transfer rollers, and
wherein center positions of said first transfer portion and said second transfer portion with respect to the rotational moving direction of said intermediary transfer belt are deviated from center positions of said first contact region and said second contact region with respect to the rotational moving direction of said intermediary transfer belt, respectively, toward a downstream direction with respect to the rotational moving direction of said intermediary transfer belt.

11. An apparatus according to claim 9, wherein the detection mode operation is executed in a period from application of the first detection current and the second detection current to said first electroconductive transfer roller and said second electroconductive transfer roller, respectively, to passage of all portions of said intermediary transfer belt, with respect to the rotational moving direction, through at least one of said first transfer portion and said second transfer portion.

12. An apparatus according to claim 9, wherein where L is a circumferential length of said intermediary transfer belt, and S is a distance between said first transfer portion and said second transfer portion in the rotational moving direction, and
wherein the detection mode operation is carried out from application of the first detection current and the second detection current to said first electroconductive transfer roller and said second electroconductive transfer roller, respectively, to rotation of said intermediary transfer belt through a distance equal to L−S.

13. An apparatus according to claim 9, wherein said controller applies, during an image forming operation, the first transfer voltage and the second transfer voltage to said first electroconductive transfer roller and said second electroconductive transfer roller, respectively, on the basis of a surface potential of said first photosensitive member at a position upstream of said first contact region with respect to the rotational moving direction of said photosensitive member and a detection result of said first detecting member, and on the basis of a surface potential of said second photosensitive member at a position upstream of said second contact region with respect to the rotational moving direction of said photosensitive member and a detection result of said second detecting member.

14. An apparatus according to claim 9, further comprising switching means for switching between an operation state in which said second photosensitive member and said intermediary transfer belt contact with each other and an operation state in which said second photosensitive member and said intermediary transfer belt are spaced from each other, while said first photosensitive member and said intermediary transfer belt are in a contact state with each other,
wherein said executing portion executes the detection mode operation while said switching means maintains the contact state of said first photosensitive member with said intermediary member.

15. An apparatus according to claim 9, wherein a plurality of photosensitive members is provided along the rotational moving direction of said intermediary transfer belt, and
wherein said first photosensitive member is one of said plurality of photosensitive members, and said second photosensitive member is an other of said plurality of photosensitive members.

16. An apparatus according to claim 15, wherein said first photosensitive member is one of a most upstream and a most downstream of said plurality of photosensitive members with respect to the rotational moving direction of said intermediary transfer belt, and said second photosensitive member is the other of the most upstream and the most downstream of said plurality of photosensitive members.
